(19) United States
(12) Patent Application Publication
(10) Pub. No.: US 2021/0133814 A1
(43) Pub. Date: May 6, 2021

(54) Method and System for Use of Automatic Content Recognition to Trigger Dynamic Ad Insertion in Response to Repeat Playout of Ad

(71) Applicant: The Nielsen Company (US), LLC, New York, NY (US)

(72) Inventors: Kurt R. Thielen, Maple Grove, MN (US); John R. Burbank, New York, NY (US)

(21) Appl. No.: 16/668,833

(22) Filed: Oct. 30, 2019

(51) Int. Cl. G06Q 30/02; H04L 29/06

(52) U.S. Cl. CPC G06Q 30/0269; H04N 21/812; H04L 65/601

(57) ABSTRACT

A computing system detects, through automatic content recognition (ACR), that a particular ad has been presented threshold many times by a set of one or more content presentation devices, such as a single content presentation device or multiple content presentation devices associated with a common user. And responsive to the detecting, the computing system implements dynamic ad insertion (DAI) to automatically substitute presentation of a replacement ad for presentation of the particular ad a next time the particular ad would be presented by a content presentation device of the set. Optimally, the process could thereby help to avoid continued monotonous presentation of the same ad by the set of one or more content presentation devices.

### BACKGROUND

A typical content presentation device operates to receive analog or digital media streams representing media content such as video and/or audio content and to render and present the media content on a user interface such as a display screen and/or an audio speaker. Examples of such devices include, without limitation, televisions, computer monitors, projection systems, radios, loudspeakers, headphones, and the like.

In many cases, the media streams received and rendered by such content presentation devices could include both programming content and advertisements. For instance, television broadcasts could include both television programs and commercials. And likewise, radio broadcasts could include both radio programs and commercials.

### SUMMARY

One technological problem that can occur with presentation of media streams that include both programming content and ads is that the same ad may be presented too many times, possibly to the point that presentation of the ad becomes monotonous and counter-productive.

The present disclosure provides a technological solution to help address this problem. In accordance with the disclosure, a computing system will use automatic-content-recognition (ACR) as a basis to detect that a particular ad has been presented threshold many times by a set of one or more content presentation devices, such as content presentation devices associated with a given user (e.g., individual user, household, or other media-consumption entity). And in response to detecting this situation, the computing system will configure application dynamic ad insertion (DAI) that will cause presentation of a replacement ad in place of the particular ad the next time (i.e., a subsequent time) the particular ad would be presented by a content presentation device of the set.

This process could be carried out with respect to a single such content presentation device, i.e., where the set of one or more content presentation devices is a single content presentation device. In that scenario, the computing system could determine that that content presentation device has presented the particular ad threshold many times and could responsively take action to trigger application of DAI for the next time the particular ad would be included in a media stream being presented by the content presentation device.

Alternatively, the process could be carried out with respect to a group of such content presentation devices, i.e., where the set of one or more content presentation devices is multiple content presentation devices. In that scenario, the computing system could determine that the particular ad has been presented threshold many times in total by the content presentation devices of the set (e.g., as a total across individual ones of the content presentation devices of the set, possibly correlated with each other by being associated with a common account or the like). And the computing system could responsively take action to trigger application of DAI for each content presentation device of the set, so that the DAI would apply the next time the particular ad would be included in a media stream being presented by any one of the content presentation devices of the set.

The computing system that carries out this process could include one or more content presentation devices of the set, i.e., one or more such content presentation devices that present the one or more media streams. Alternatively or additionally, the computing system could include one or more other entities privy to one or more media streams presented (e.g., being presented, about to be presented, or previously presented) by one or more such content presentation devices, among other possibilities.

By way of example, an individual content presentation device could detect its own presentation of the particular ad threshold many times and could then responsively take action facilitate dynamic replacement of the ad the next time the ad is included in a media stream that that content presentation device is presenting. As another example, multiple content presentation devices in the set could detect and report instances of their presentation of the particular ad, and one of the content presentation devices or a server or other entity could tally the number of such instances over time, could detect that the particular ad has been presented threshold many times in total by the set of content presentation devices, and could responsively take action to facilitate dynamic replacement of the ad the next time the ad is included in a media stream that a content presentation device of the set of presenting. And as yet another example, one or more network servers having access to one or more media streams presented by one or more content presentation devices of the set could detect presence of the particular ad threshold many times within the media stream(s) presented and could responsively take action to facilitate dynamic replacement of the ad the next time it is included in a media stream that a content presentation device of the set is presenting. Variations and combinations of these or other examples could be possible as well.

In a representative implementation, the computing system could engage in ACR with respect to one or more media streams presented by the set of content presentation devices (e.g., being presented, about to be presented, or having been presented by one or more content presentation devices of the set), in order to detect multiple instances of the particular ad within the one or more media streams presented, and thus to detect multiple instances of presentation of the particular ad by the set of content presentation devices. Further, the ACR could take various forms, such as fingerprint-based ACR and/or metadata-based ACR, among other possibilities.

With fingerprint-based ACR, the computing system could compare digital query fingerprints representing the media stream with pre-established digital reference fingerprints representing the particular ad and could find one or more fingerprint matches indicating one or more instances of the particular ad in the media stream.

For instance, a content presentation device that presents the media stream or another entity privy to the media stream presented by the content presentation device could generate the digital query fingerprints representing the media stream presented and could compare the digital query fingerprints with the digital reference fingerprints to find one or more fingerprint matches indicating one or more instances of the particular ad in the media stream. Or such an entity could transmit the digital query fingerprints to one or more other entities that could perform the fingerprint matching to find the one or more instances of the particular ad in the media stream.

Whereas with metadata-based ACR, the computing system could obtain metadata that is associated with the media stream and that indicates the presence of one or more instances of the particular ad in the media stream. Such metadata could take various forms, and the act of the computing system obtaining the metadata could therefore also take various forms.

By way of example, for each instance of the particular ad in the media stream, the media stream could be steganographically encoded with a watermark (e.g., an audio or video watermark) that indicates presence of the particular ad and identifies ad. In that case, the computing system could decode and read one or more such watermarks from the media stream, indicating corresponding presence of one or more instances of the particular ad in the media stream. For instance, the content presentation device that presents the media stream or another entity privy to the media stream presented by the content presentation device could decode and read one or more such watermarks from the media stream, indicating the corresponding presence of one or more instances of the particular ad in the media stream.

Alternatively, if the media stream is carried in a transport stream (e.g., as payload in a packet-data stream), then, for each instance of the particular ad in the media stream, the transport stream could carry header information or one or more special packets indicating presence of the particular ad and identifying the ad. And in that case, the computing system could read that metadata from the transport stream, indicating the corresponding presence of one or more instances of the particular ad in the media stream. For instance, the content presentation device or another entity privy to the transport stream that carries the media stream presented by the content presentation device could read such metadata from the transport stream, indicating the corresponding presence of one or more instances of the particular ad in the media stream.

Through these or other ACR processes, the computing system could thus detect multiple instances of the particular ad being presented by the set of one or more content presentation devices associated with the user. Tracking those instances, the computing system could then determine that the extent of presentation of the particular ad by the set of content presentation devices meets or exceeds a predefined threshold, such as that the set of content presentation devices has presented the particular ad at least a threshold number of times and/or at at least a threshold rate (e.g., number of times per hour, day, or other unit of time).

In response to at least detecting that the tracked extent of presentation of the particular ad by the set of content presentation devices meets or exceeds the predefined threshold, the computing system could then trigger a DAI process that will work to replace the particular ad the next time the particular ad would otherwise be presented by a content presentation device of the set. For instance, the computing system could responsively set itself to apply this DAI process, or the computing system could responsively signal to another entity or system to cause the other entity or system to apply the DAI process.

Further, as noted above, this DAI process could be applied with respect to each of the one or more content presentation devices of the set, so as to help ensure that that a next instance of the particular ad by a content presentation device of the set would be replaced.

The DAI process carried out with respect to a given content presentation device could itself take various forms. As a non-limiting example, for instance, an ACR server could engage in ACR (e.g., fingerprint-based and/or metadata based as discussed above) with respect to a media stream that is determined to be en route to the content presentation device, to detect within that media stream an instance of the particular ad. The ACR server could then engage in out-of-band signaling with the content presentation device to give the content presentation device advanced notice that the particular ad is about to be included in the media stream being presented by the content presentation device, and to prepare the content presentation device to replace that particular ad with a replacement ad.

In response to this signaling from the ACR server, the content presentation device could then obtain the replacement ad, such as by querying an ad-replacement server or by retrieving a replacement ad from local data storage.

Further, this signaling from the ACR server to the content presentation device could provide the content presentation device with information that enables the content presentation device to engage in ACR with respect to the media stream so as to identify when the particular ad is about to be presented, so that the content presentation device can play out the replacement ad at that point in the media stream.

For instance, the ACR server could provide the content presentation device with digital reference fingerprints representing at least the start of particular ad (or the end of content immediately preceding the particular ad in the media stream), so that the content presentation device could compare those digital reference fingerprints with digital query fingerprints representing the media stream being presented in order to detect when presentation of the particular ad would start. Or the ACR server could provide the content presentation device with watermark coding information associated with a watermark encoded in the media stream indicating that the particular ad is about to start, so that the content presentation device could detect that watermark as an indication that presentation of the particular ad is about to start.

When the particular ad is about to be presented, the content presentation device could then switch to present the replacement ad instead of presenting the particular ad, thus completing the DAI process with respect to that instance of the particular ad.

This process of detecting a threshold extent of presentation of a particular ad by a set of one or more content presentation devices associated with a common user and responsively replacing a next such presentation of the particular ad by a content presentation device of the set could help to improve user interest in advertising of an associated brand. For example, once a particular ad for a brand product or service has been presented threshold many times by the set of one or more content presentation devices, the process could optimally cause a next presentation of the particular ad by a content presentation device of the group to be replaced with presentation of a different ad for the same brand—thus helping to avoid continued, monotonous repetition of the same ad for the brand. Further a similar process could be carried out more generally for a set of one or more content presentation devices, regardless of their association with a common user.

These as well as other aspects, advantages, and alternatives will become apparent to those of ordinary skill in the art by reading the following detailed description, with reference where appropriate to the accompanying drawings. Further, it should be understood that the descriptions provided in this summary and below are intended to illustrate the invention by way of example only and not by way of limitation.

### BRIEF DESCRIPTION OF THE DRAWINGS

FIG. 1 is a simplified block diagram of an example arrangement in which various disclosed principles can be implemented.

FIG. 2 is a simplified block diagram of an media delivery system in which various disclosed principles can be implemented.

FIG. 3 is a simplified block diagram of a network arrangement in which various disclosed principles can be implemented.

FIG. 4 is a flow chart depicting operations that can be carried out in accordance with the present disclosure.

FIG. 5 is a simplified block diagram of an example computing system.

FIG. 6 is a simplified block diagram of an example content presentation device.

### DETAILED DESCRIPTION

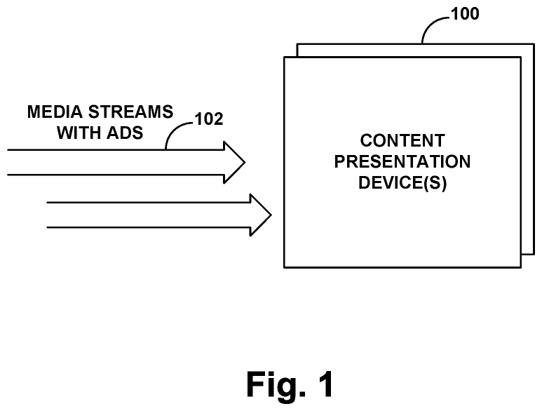

Referring to the drawings, as noted above, FIG. 1 is a simplified block diagram of an example arrangement in which various disclosed principles can be applied. It will be understood, however, that this and other arrangements and processes described herein can take various other forms. For instance, elements and operations can be re-ordered, distributed, replicated, combined, omitted, added, or otherwise modified. Further, it will be understood that functions described herein as being carried out by one or more entities could be implemented by and/or on behalf of those entities, through hardware, firmware, and/or software, such as by one or more processing units executing program instructions or the like.

FIG. 1 depicts one or more content presentation devices 100, each of which could be any of the types of content presentation devices noted above, among other possibilities. As discussed above, one implementation could relate to a single content presentation device, and another implementation could relate to multiple content presentation devices associated with a common user such as an individual, household, business, or other media-consumption entity. As such, each such content presentation device could have respective device identifier, which could be registered and stored in association with a particular user, possibly recorded through a device configuration or registration process in a database relationship with a user account or the like.

As shown in FIG. 1, the content presentation device(s) could receive one or more media streams 102 for presentation, which the content presentation device(s) could present on integrated or external media presentation interfaces 104 such as display screens, audio speakers or the like.

In an example implementation, each such media stream might be a linear sequence of media content that includes program content and interspersed ad content, with the sequence of media content being statically or dynamically defined. For instance, a media stream could be a linear broadcast of a television channel, radio station, streaming media session, or the like, divided over time into a sequence of live and/or prerecorded programs (e.g., television shows, movies, radio segments, etc.) with interspersed commercial breaks in which one or more media segments over time define discrete ads that promote goods or services. And as another example, the media stream could be a sequence of dynamically generated real-time gaming content that varies based on ongoing game play over time and also includes interspersed commercial breaks in which media segments over time define discrete ads.

An example content presentation device may present such a media stream in real time as the content presentation device receives the media stream. Alternatively, the content presentation device may be able to store the media stream for later presentation and may then later retrieve the media stream from storage and present the media stream. In any event, as the content presentation device presents one or more such media streams, the content presentation device may from time to time present ads included within the media streams.

In practice, each content presentation device as shown in FIG. 1 could receive these media streams through any of a variety of media delivery systems.

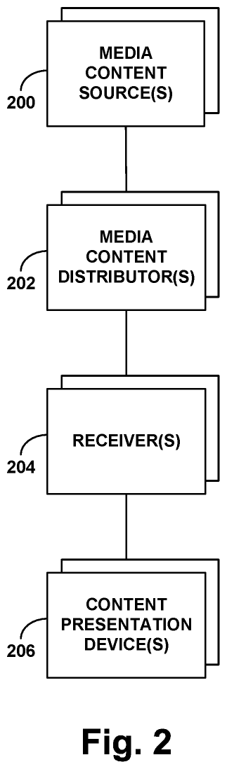

FIG. 2 depicts a non-limiting example of such a media delivery system. As shown in FIG. 2, the media delivery system includes one or more media content sources 200 (e.g., broadcasters, web servers, etc.), one or more media content distributors 202 (e.g., multi-channel distributors, such as cable providers, satellite providers, over-the-air broadcast providers, web aggregators, streaming-media service providers, etc.), one or more media content receivers 204 (e.g., cable receivers, satellite receivers, over-the-air broadcast receivers, computers or other streaming media receivers, etc.), and one or more content presentation devices 206 (e.g., televisions or other display devices, loudspeakers or other audio output devices, etc.)

With this example arrangement, the media content sources 200 could deliver various media streams to the media content distributors 202 for distribution to media content receivers 204 at customer premises, the media content distributors 202 could distribute the media streams to the media content receivers 204, the media content receivers 204 could output the media streams for presentation by the content presentation devices 206, and the content presentation devices 206 could present the media streams.

As a specific example of this arrangement, the media content sources 200 could be national broadcasters, such as ABC, NBC, CBS, FOX, HBO, and CNN, the media content distributors 202 could be local affiliates and/or other local content distributors, possibly for specific designated market areas (DMAs), and the media content receivers 204 and content presentation devices 206 could then be situated at customer premises, such as homes or business establishments. For instance, an example content presentation device 206 could be a television situated at customer premises, which could be coupled by an HDMI cable with a cable-TV set top box, and the set top box could be coupled through a local distribution network with a cable-TV head end that distributes various television channels provided by national and/or local broadcasters. The television could thus receive a media stream via HDMI from the set top box, and the set top box could tune to a particular channel from the head end in response to user input, so that the media stream being presented by the television would be the user-selected channel.

And as another example, a television situated at customer premises could alternatively be connected by an HDMI cable with a streaming-media receiver such as an APPLE TV, ROKU, AMAZON FIRE, or CHROMECAST device, or a computer or other device, which could be in network communication with a streaming-media server such as virtual multichannel video programming distributor (virtual-MVPD) that distributes various channels of content. In this arrangement, the television could regularly receive a media stream via HDMI from the streaming-media receiver, and the streaming-media receiver could work with the streaming-media server to cause the streaming-media server to deliver to the streaming-media receiver a particular user-selected channel, which the streaming-media receiver could output in its media stream to the television. Thus, here too, the media stream arriving at the television would likewise represent the user-selected channel.

As noted above, the present disclosure provides for using ACR to detect threshold many instances of presentation of a particular ad threshold by a set of one or more content presentation devices, and for responding to that situation by triggering DAI with respect to a next presentation of that particular ad by the set of one or more content presentation devices. Optimally as noted above, the result of the DAI would be that the next time the particular ad would otherwise presented by a content presentation device of the set, the ad would be automatically replaced with a replacement ad, so that the content presentation device would instead present the replacement ad—thus helping to avoid monotony of continued repeat presentation of the same ad.

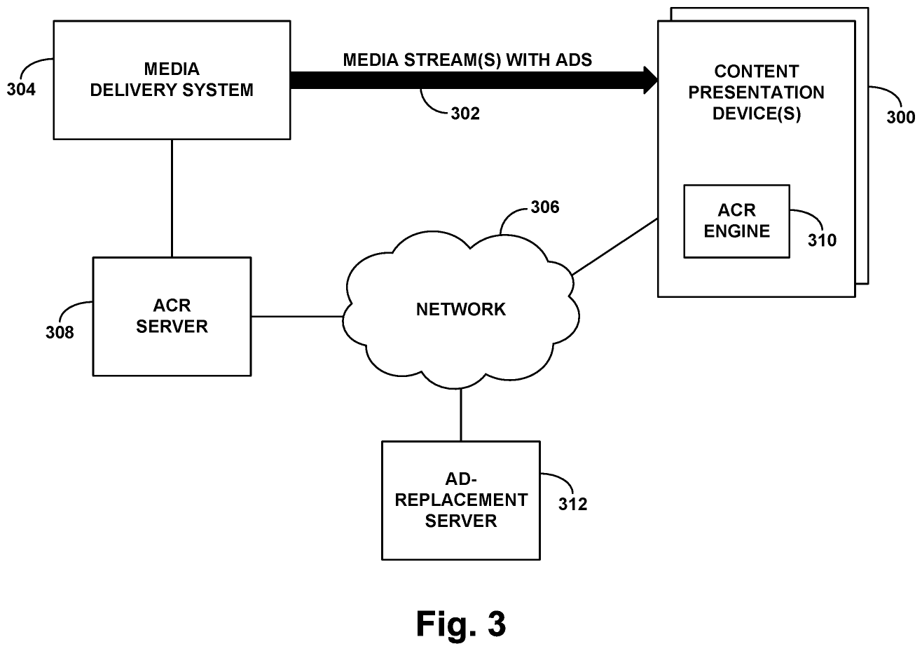

FIG. 3 is a simplified block diagram of a network arrangement in which features of this process could be carried out by way of example.

FIG. 3 shows at its top one or more representative content presentation devices 300 that may receive from time to time one or more media streams 302 provided by a content delivery system 304. By way of example, each such content presentation device 300 could be an example content presentation device 200 as shown in FIG. 2, and the content delivery system 304 could comprise a representative media content source 200, media content distributor 202, and/or receiver 204 as shown in FIG. 2.

As such, a content presentation device 300 could receive a media stream 302 directly or indirectly from the content delivery system 304 and could render the media stream for presentation. The media stream might be a linear broadcast feed and/or a streaming media channel, among other possibilities, and the content presentation device 300 might receive the media stream through any of a variety of distribution channels, such as but not limited to cable, satellite, terrestrial over-the-air broadcast, broadband streaming, or others now known or later developed. Alternatively, the content presentation device 300 may receive one or more media streams from local data storage, among other possibilities.

In an example implementation, the content of each such media stream could define a respective sequence of digital frames of media content (e.g., video frames, each being a respective image or the like) that a recipient content presentation device could render for presentation to a user. A media content source, media content distributor, and/or other entity might broadcast, stream, or otherwise provide this sequence of frames for ultimate delivery and presentation by one or more content presentation devices. For instance, the entity might broadcast the media stream encapsulated in a transport stream, and a receiver integrated or interconnected with the content presentation device might receive the transport stream, extract the sequence of frames from the transport stream, and output the sequence of frames as the media stream for presentation by a content presentation device.

As further shown in FIG. 3, each example content presentation device could be interconnected with a communication network 306, which could be a packet-switched network such as the Internet. For instance, the content presentation device 300 could sit as a node on a local area network (LAN) at customer premises, with the content presentation device having an assigned Internet Protocol (IP) address on the LAN and the LAN having an IP address on the network 306. The content presentation device 300 might thereby be able to engage in data communication with various entities via the network 306 while the content presentation device 300 is presenting a media stream.

Shown accessible via the network 306 (e.g., at a defined IP address on the network) is a ACR server 308, which could facilitate various ACR operations described herein. For instance, the ACR server 308 might interwork with an ACR engine 310 (e.g., a programmed processing unit) in each content presentation device 300 and/or in one or more other entities, to facilitate detecting instances of presentation of the particular ad and implementing DAI to replace presentation of the particular ad with a replacement ad.

Further shown accessible via the network 306 is an ad-replacement server 312, which could interwork with the ACR server 308 and with each content presentation device 300 to also facilitate detecting and replacing the particular ad. In an example implementation, the ad-replacement server 312 could be provisioned with data specifying the particular ad and data specifying a replacement ad (e.g., for the same brand of good or service) to be substituted for the particular ad when appropriate. This data might include actual recordings of the ads as well as ad identifiers and other information. In practice, an advertiser might work directly or indirectly to provision the ad-replacement server 312 or one or more other entities with this data.

In the example arrangement of FIG. 3, various forms of ACR could be applied at various entities to detect instances of presentation of the particular ad so as to facilitate detecting threshold many instances of presentation of the particular ad by a set of content presentation devices.

As discussed above, example forms of ACR include fingerprint-based ACR and metadata-based ACR. As noted above, fingerprint-based ACR could involve comparing digital query fingerprints representing media content being presented by a content presentation device with digital reference fingerprints representing the particular ad, and deeming a fingerprint match to indicate that the content presentation device is presenting the particular ad. Whereas, metadata-based ACR could involve detecting in or with the media stream being presented by the content presentation device metadata, such as a watermark or transport-stream header data, that indicates the presence of the particular ad in the media stream, thus establishing that the content presentation device is presenting the particular ad.

To facilitate fingerprint-based ACR in the arrangement of FIG. 3, the ACR server 308 could receive from the ad-replacement server 312 a copy of the particular ad and could generate digital reference fingerprints representing individual frames of the particular ad. The ACR server 308 could apply any digital fingerprinting process now known or later developed for this purpose.

Without limitation, an example digital fingerprinting process as to video content could apply on a per video frame basis and could involve establishing a representation of luminosity and/or other video characteristics. For instance, for a given video frame, a fingerprint generator could programmatically divide the frame into a grid, and the fingerprint generator could measure luminosity of the frame per grid cell and generate a bit string with each bit or series of bits representing luminosity of a respective grid cell, or representing a weighted difference between the luminosity of certain defined pairs of the grid cells, or the like. Further, the fingerprint generator could apply this process continually to generate the digital fingerprint over time as a sequence of fingerprints (e.g., as a fingerprint stream). For instance, the fingerprint generator could apply this process to each frame, to each key frame, periodically, or on another defined basis, with each frame's bit string defining a digital fingerprint and/or with a specified hash, combination or series of such bit strings or other representative values defining a digital fingerprint, on a sliding window basis. Other digital fingerprinting processes could be used as well.

The ACR server 308 could store those reference fingerprints representing the particular ad for later use to facilitate server-side fingerprint-matching and detecting of instances of presentation of the particular ad. Further, the ACR server 308 could transmit to each of the one or more of the content presentation devices 300 the reference fingerprints representing the particular ad, to facilitate client-side fingerprint matching and detecting of instances of presentation of the particular ad.

As each such content presentation device presents a media stream, the ACR engine 310 at the content presentation device may generate digital query fingerprints representing individual frames of the media stream, using the same fingerprint-generation process applied to generate the reference fingerprints representing the particular ad. And as the ACR engine 310 device generates these query fingerprints, the ACR engine 310 could compare the query fingerprints with the reference fingerprints in an effort to find a fingerprint match, or the content presentation device 300 could transmit to the ACR server 308 the query fingerprints, and the ACR server could compare the query fingerprints with the reference fingerprints in an effort to find a fingerprint match.

To compare a given query fingerprint with a given reference fingerprint, the ACR server 308 or content presentation device 300 could compare corresponding portions of the fingerprints with each other to determine whether the portions match exactly or within defined tolerances. For example, the server or device could compute a maximum deviation between the fingerprints and determine if the maximum deviation is within a predefined tolerance. Further, if the fingerprints are binary, this could be a Boolean determination or could involve computing a Hamming distance (as a count of mismatches between respective bit locations in the fingerprints), and if the fingerprints are more complex values, such as decimal values or vectors (e.g., grey values per video frame region), this could involve determining a distance between the values or vectors. Numerous other examples are possible as well.

Upon finding with sufficient certainty that the query fingerprints representing the media stream being rendered by the media presentation device match the reference fingerprints representing the particular ad, the ACR server 308 or content presentation device could deem the fingerprint match to establish an instance of the content presentation device presenting the particular ad. The ACR server 308 or content presentation device 300 could add this instance to a count of instances of the content presentation device presenting the particular ad.

Further, the ACR server 308 or content presentation device 300 may report the detected instance to one or more other entities responsible for tracking a total count of instances of presentation of the particular ad by the content presentation device and/or by a group of content presentation devices associated with a common user. Reporting each such instance could include reporting the identity of the content presentation device presenting the ad, which as noted above could be associated with a particular user. Thus, reports of such presentation by more than one content presentation device associated with the same user could be aggregated to establish a total count of instances of presentation of the particular ad by that set of content presentation devices.

Variations on this process could be possible as well. For example, in another implementation, the ACR server 308 could use ACR to determine initially what media stream a content presentation device is presenting and could then detect within that media stream an instance of the particular ad. Having determined that the content presentation device is presenting a given media stream and determined that the given media stream includes the particular ad, the ACR server 308 could thereby conclude that the particular ad is being presented the content presentation device.

To facilitate this, the ACR server 308 might be provisioned with reference data including reference fingerprints representing the frames of each of various media streams that could be delivered to content presentation devices. For instance, the ACR server 308 or associated watching stations, possibly integrated with the media delivery system 304, could generate these reference fingerprints per media stream. Further, as a content presentation device presents a given media stream, the content presentation device could generate query fingerprints as discussed above and could transmit the query fingerprints to the ACR server 308 for analysis. And the ACR server 308 could compare those query fingerprints with the reference fingerprints representing each of various media streams, in an effort to find a match. Upon finding that the query fingerprints match the reference fingerprints representing a particular media stream, the ACR server 308 could then conclude that that is the media stream being presented by the content presentation device.

Once the ACR server 308 determines which media stream is being presented by the content presentation device, the ACR server 308 could then conduct a fingerprint analysis of that determined media stream as the media stream is en route to the content presentation device, in an effort to detect within that media stream the particular ad. For instance, the ACR server 308 could compare the fingerprints representing the particular ad with the fingerprints representing the media stream en route to the content presentation device. And upon finding a match with sufficient certainty, the ACR server 308 could deem that match to establish an instance of the media stream being presented by the content presentation device including the particular ad.

The ACR server 308 could then accordingly add this instance to a count of instances as to that content presentation device and/or a set of content presentation devices associated with a common user. Or the ACR server 308 could report the instance to another entity responsible for tracking that count as noted above.

Further, note that a similar ACR analysis could be carried out at one or more other entities in the arrangement of FIG. 3 to facilitate detecting instances of presentation of the particular ad by a set of one or more content presentation devices. For instance, an entity of the media distribution system that is aware of and has privy to the media stream being presented by a given such content presentation device could conduct the fingerprint analysis. By way of example, a virtual-MVPD or a set top box that transmits a media stream to a television or other content presentation device could carry out the analysis. To facilitate this, the ACR server 308 could transmit to such an entity the reference fingerprints representing the particular ad, and an ACR engine at the entity could generate query fingerprints of the media content en route to the content presentation device and could work to find a match. Upon finding a fingerprint match with sufficient certainty, the entity could then add and/or report that as an instance of the content presentation device presenting the particular ad.

To facilitate use of metadata-based ACR, on the other hand, for detecting one or more instances of presentation of the particular ad by a set of one or more content presentation devices in the arrangement of FIG. 3, each instance of the particular ad in a media stream would have associated metadata that indicates the presence of the ad in the media stream, and one or more entities could be configured to detect presence of that metadata as an indication of the presence of the ad in a media stream being presented by a content presentation device.

In practice, an entity that inserts the particular ad into the media stream could add into the media stream a metadata indication of the presence of the particular ad. For example, in generating the media stream containing an instance of the particular ad, a computing system could steganographically encode as a watermark in the media stream an ad-identifier of the particular ad, possibly time aligned or otherwise associated with the presence of the ad in the media stream.

Such a watermark might be on the order of 24 bits and could be done in an audio component and/or a video component, depending on the form of the media content for instance. Existing audio watermarking techniques include, without limitation, inserting audio energy into the audio signal or otherwise adjusting one or more characteristics of the audio signal in a manner that can be detected by a suitably configured watermark-detection algorithm but that is masked from hearing (e.g., the audio characteristic and/or manner of encoding being sufficient to hide the watermark from human detection)—known as stenographic or psychoacoustic encoding. And existing video watermarking techniques involve embedding a code in a video component of the media content in a manner that can be detected by a suitably configured watermark-detection algorithm but that is masked from human visual detection.

Alternatively or additionally, an entity that inserts the particular ad into the media stream could add into a transport stream carrying the media stream a metadata indication of the presence of the particular ad. As noted above, such metadata could be provided in the header of a transport-stream packet and/or as payload in a specially designated transport-stream packet. Examples of this sort of metadata might make use of industry standard protocols such as the Society of Cable and Telecommunications Engineers (SCTE) and the Advanced Television Systems Committee (ATSC), among other possibilities. Here too, the metadata could be the ad-identifier of the particular ad. And the metadata could be included in a transport stream packet time-aligned with the presence of the particular ad in the media stream.

In practice, the ACR engine 310 of each of one or more of the content presentation devices could then be provisioned with the ad-identifier or other metadata associated with the particular ad and could work to detect the presence of that metadata as the content presentation device presents the media stream.

For instance, if the metadata indication of a given instance of the particular ad is watermarked into the media stream, the content presentation device could find and decode the watermark in the media stream, thereby detecting that instance of the particular ad in the media stream being presented by the content presentation device. Or if the metadata indication of a given instance of the particular ad is included in a transport stream packet that is received by the content presentation device, the content presentation device could find and read that metadata, likewise detecting that instance of the particular ad in the media stream being presented by the content presentation device.

For each such instance of presentation of the particular ad as established based on detecting metadata indicating the presence of the particular ad, the content presentation device could then record and/or report this instance in the manner discussed above.

Further, as with the fingerprint analysis discussed above, one or more other entities could similarly detect metadata indicating the presence of the particular ad in the media stream that is being presented a content presentation device. For instance, the ACR server 308 could provide the ad-identifier to an entity in the media delivery system 304 that is aware of a media stream en route to the content presentation device, and an ACR engine at that entity could likewise search for associated metadata in the media stream indicating the presence of the particular ad in the media stream being presented by the content presentation device. The entity could then record and/or report that instance also as discussed above.

Through these or other ACR processes, one or more entities could thus detect multiple instances of each of one or more content presentation devices presenting the particular ad. As noted above, for instance, a content presentation device itself could keep track of the instances of its own presentation of the particular ad, either through its own detecting one or more such instances and/or based on reports from one or more other entities indicating one or more instances of the content presentation device presenting the ad. Alternatively, the ACR server 308 might keep track of the instances of a given content presentation device presenting the particular ad, through the ACR server having detected each such instance and/or based on reports from other entities indicating such instances. Still alternatively, a content presentation device, the ACR server, or another entity could keep track of the total of such instances for a group of content presentation devices all associated with a common user, based on device identifier information as discussed above.

One or more such entities could then determine when the particular ad has been presented at least a predefined threshold many times (e.g., per unit time) by a set of one or more content presentation devices. This threshold could be set to a value that is two or more and that is deemed high enough from a marketing perspective such that it would be worthwhile after so many instances of presentation of the particular ad by the set of one or more content presentation devices to then replace the particular ad the next time a content presentation device of the set would otherwise present it.

Upon detecting this situation, the entity may then trigger a DAI process as noted above, to facilitate replacement of the particular ad the next time a content presentation device of the set of one or more content presentation devices would otherwise present the ad. Applying the DAI process could take various forms.

By way of example, in a scenario where a single content presentation device determines, by itself or through interworking with one or more other entities, that it has presented the particular ad at least the predefined threshold number of times, the content presentation device could then automatically work to replace the particular ad the next time the content presentation device would otherwise present the particular ad.

To facilitate this, the content presentation device could engage in signaling via network 306 with the ad-replacement server 312 to obtain a replacement ad to be presented in place of the particular ad. The content presentation device could then work to detect presence of the particular ad in a media stream that the content presentation device is presenting, such as through one or more of the ACR processes discussed above. And upon detecting the presence of the particular ad in the media stream that the content presentation device is presenting, the content presentation device could substitute presentation of the obtained replacement ad for presentation of the particular ad.

Alternatively or additionally, the ACR server 308 could coordinate the DAI process for each content presentation device of the set of one or more content presentation devices at issue.

In an example implementation, for instance, for each such content presentation device, the ACR server 308 could engage in signaling with the content presentation device to inform the device that the content presentation device should replace a next instance of the particular ad with a replacement ad. Further, the ACR server 308 could provide each such content presentation device with reference fingerprints representing the particular ad and/or with metadata associated with the particular ad (if the content presentation device does not have that information already), to enable the content presentation device to then detect presence of the particular ad and to replace presentation of the particular ad with presentation of a replacement ad as discussed above.

Optimally through this process, once the set of one or more content presentation devices associated with a given user has thus presented the particular ad threshold many times, the next time a content presentation device of the set would present the particular ad, the content presentation device could replace the ad with a replacement ad, thus helping to avoid continued monotonous presentation of the same ad.

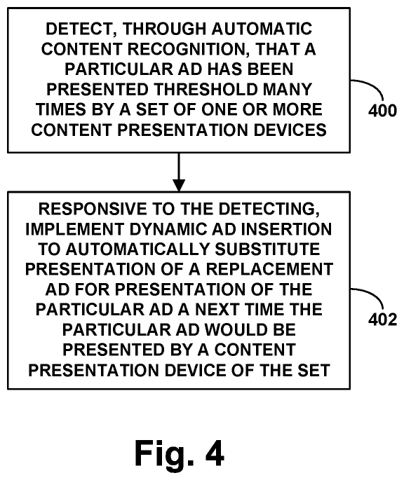

FIG. 4 is next a flow chart depicting a method that can be carried out in line with the discussion above. One or more of the operations in the method depicted by FIG. 4 could be carried out by computing system that could include one or more entities, such as, without limitation, one or more of the content presentation devices 300, the ACR server 308, the ad-replacement server 312, and one or more entities of the media delivery system 304. Namely, one or more such entities could individually or cooperatively define a computing system, which could include at least one processing unit (e.g., one or more general purpose processors such as microprocessors, and/or one or more special purpose processors such as application specific integrated circuits or the like), non-transitory data storage (e.g., disc storage, flash storage, or other computer readable medium), and program instructions stored in the non-transitory data storage and executable by the at least one processing unit to carry out operations of the method.

As shown in FIG. 4, at block 400, the method includes detecting, through ACR, that a particular ad has been presented threshold many times by a set of one or more content presentation devices. And at block 402, the method includes, responsive to the detecting, implementing DAI to automatically substitute presentation of a replacement ad for presentation of the particular ad a next time the particular ad would be presented by a content presentation device of the set.

In line with the discussion above, the ACR used in this method could include a fingerprint-based ACR process and/or a metadata-based ACR process. For instance, just fingerprint-based ACR may be used or just metadata-based ACR may be used. Alternatively, one or more instances of the presentation of the particular ad could be detected through fingerprint-based ACR, and one or more other instances of the presentation of the particular ad could be detected through metadata-based ACR. Or a combination of fingerprint-based ACR and metadata-based ACR might be used to detect a given instance of presentation of the particular ad.

As discussed above, the fingerprint-based ACR could involve using fingerprint matching, between digital reference fingerprint data representing the particular ad and digital query fingerprint data representing media content presented by a content presentation device of the set, as a basis to detect a given instance of presentation of the particular ad.

Further, as discussed above, the metadata-based ACR could involve a scenario where a media stream carrying media content including the particular ad is steganographically encoded with a watermark indicating presence in the media stream of the particular ad, in which case the metadata-based ACR could involve using the steganographically encoded watermark as a basis to detect a given instance of presentation of the particular ad by a content presentation device that presents the media stream. And alternatively or additionally, the metadata-based ACR could involve a scenario where a transport stream carrying a media stream including the particular ad further carries metadata indicating presence in the media stream of the particular ad, in which case the metadata-based ACR could involve using the metadata carried by the transport stream as a basis to detect a given instance of presentation of the particular ad by a content presentation device that presents the media stream.

As further discussed above, the act of detecting, through ACR, that a particular ad has been presented threshold many times by a set of one or more content presentation devices could involve receiving signaling generated based on the ACR establishing presentation of the particular ad by the set of one or more content presentation devices. For instance, each time an entity detects, through ACR, an instance of presentation of the particular ad by a content presentation device of the set, the entity might report that instance to another entity that will record and track a total count of such instances by the set of one or more content presentation devices. Thus, the other entity could receive signaling that was based on the ACR having established the instance of presentation of the particular ad.

In line with the discussion above, the set of one or more content presentation devices in this method could be a single content presentation device.

Alternatively, the set could a group of multiple content presentation devices associated with a common user, in which case the act of detecting, through ACR, that the particular ad has been presented threshold many times by the set of one or more content presentation devices could involve (i) tracking a total number of presentations of the particular ad among the content presentation devices of the set, based on the content presentation devices of the set being associated with a common user, and (ii) determining that the tracked total number is at least as great as a predefined threshold number.

Here, for instance, an entity collecting data regarding the instances of presentation by content presentation devices of he set could query registration data that correlates all of the content presentation device (e.g., by their device identifiers) with a common user account, and the entity could therefore deem the instances of presentation to be by devices associated with the that common user.

Note also that, in another implementation, the threshold many instances of presentation of the particular ad could be threshold many instances of presentation of the particular ad by a single content presentation device, and DAI as to that particular ad could then responsively be triggered as to not just that content presentation device but also one or more other content presentation devices associated with the same user as the single content presentation device. For instance, once the particular ad has been presented threshold many times by a television in a household, the DAI could then apply to cause another television in that household to replace its next presentation of that particular ad with presentation instead of the replacement ad. Other examples are possible as well.

As further discussed above, the act of detecting, through ACR, that the particular ad has been presented threshold many times by the set of one or more content presentation devices comprises detecting that the set of one of more content presentation devices has presented the particular ad at least a predefined threshold great number of times, where the predefined threshold great number is a number N that is at least two (e.g., two, three, or another defined quantity). Further, this detecting could be done over a sliding window of time, so as to detect that the set of one or more content presentation devices has presented the particular ad at least a predefined threshold great number of times per unit time (e.g., per hour, per 24-hour period, or per another sliding window). And as discussed, the detecting could be carried out at least in part by the set of one or more content presentation devices, among other possibilities.

In addition, as discussed above, the act of implementing DAI to cause presentation of a replacement ad in place of the particular ad a next time the particular ad would be presented by a content presentation device of the set could involve causing the content presentation device to detect presence of the particular ad in media content that the content presentation device is presenting and to substitute presentation of the replacement ad for presentation of the particular ad.

Further, implementing the DAI could additionally involve provisioning the content presentation device with the replacement ad to be presented in place of the particular ad. For instance, this could involve the content presentation device requesting and obtaining the replacement ad from an ad-replacement server or the like, and/or this could involve an ad-replacement server, ACR server, or one or more other entities transmitting the replacement ad to the content presentation device.

And still further, implementing the DAI could involve (i) detecting, though ACR, an instance of the particular ad in media content being presented by the content presentation device and (ii) responsive to the detecting of the instance of the particular ad in the media content being presented by the content presentation device, causing the content presentation device to substitute presentation of the replacement ad for presentation of the instance of the particular ad.

As discussed above, for instance, an ACR engine at the content presentation device could detect the presence of the particular ad and could responsively cause itself to substitute presentation of the replacement ad. Further or alternatively, the ACR server might detect presence of the particular ad in a media stream that is being presented by the content presentation device and may responsively signal to the content presentation device to cause the content presentation device to substitute presentation of the replacement ad. Still further or alternatively, in another implementation, an entity in the media delivery path through which the media stream passes en route to the content presentation device could detect presence of the particular ad in the media stream and could responsively substitute into the media stream the replacement ad so that the media stream as received and presented by the content presentation device would include the replacement ad in place of the particular ad.

Other examples are possible as well.

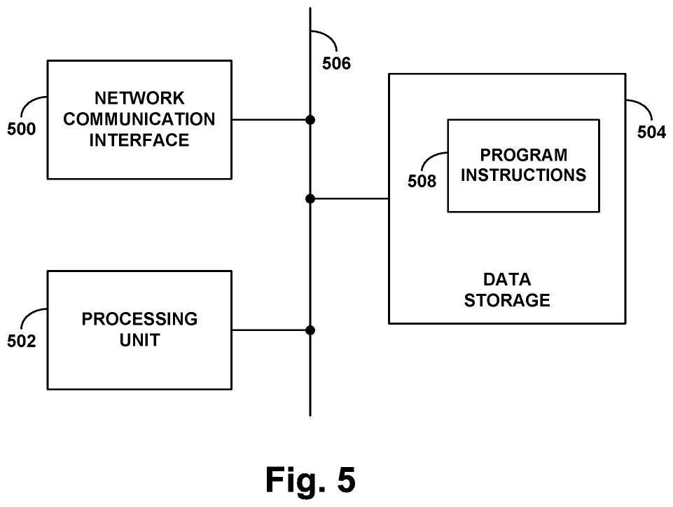

FIG. 5 is next a simplified block diagram of an example computing system operable in accordance with the present disclosure. This system could represent one or more entities (e.g., alone or in combination) as discussed above. As shown in FIG. 5, the example system includes at least one network communication interface 500, at least one processing unit 502, and at least one instance of non-transitory data storage 504, any or all of which could be integrated together in various ways or, as shown, communicatively linked together by one or more system buses, networks, and/or other connection mechanisms 506.

Each network communication interface 500 could comprise one or more network connection mechanisms to facilitate communication on a network such as network 306 discussed above, and/or for engaging in direct or networked communication with one or more other local or remote entities. As such, the network communication interface 500 could comprise a wireless or wired Ethernet interface or other type of network interface, for engaging in IP communication and/or other type of network communication, as well as network communication program logic for supporting such communication.

Each processing unit 502 could comprise one or more general purpose processors (e.g., microprocessors) and/or one or more specialized processors (e.g., application specific integrated circuits). And each instance of non-transitory data storage unit 504 could comprise one or more volatile and/or non-volatile storage components, such as optical, magnetic, or flash storage.

As shown, the non-transitory data storage 504 then stores program instructions 508, which could be executable by any of the one or more processing units 502 to carry out various operations described herein, such as the operations depicted in FIG. 3 and described above for instance.

Various features described above could be applied in this context as well, and vice versa.

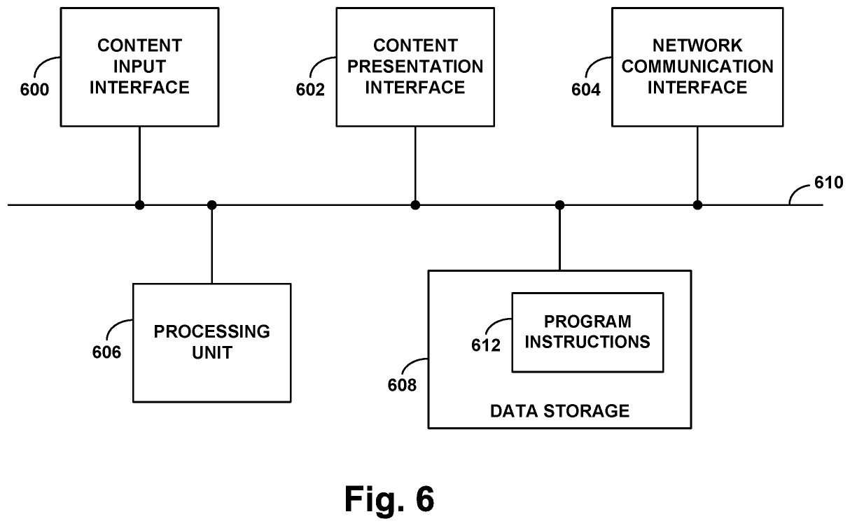

Finally, FIG. 6 is next a simplified block diagram of an example content presentation device operable in accordance with the present disclosure. In line with the discussion above, this content presentation device could take various forms. For instance, it could be a television, computer monitor, or other device that operates to receive and render video content, and/or it could be a loudspeaker, a pair of headphones, or other device that operates to receive and render audio content. Numerous other examples are possible as well.

As shown in FIG. 6, the example content presentation device includes at least one each of a media input interface 600, a media presentation interface 602, a network communication interface 604, a processing unit 606, and non-transitory data storage 608, any or all of which could be integrated together or, as shown, communicatively linked together by a system bus, network, or other connection mechanism 610.

Media input interface 600 could comprise a physical communication interface for receiving media content to be presented by the content presentation device. As such, the media input interface could include one or more wired and/or wireless interfaces for establishing communication with and receiving media content in analog or digital form from a receiver or other device or system. For example, the media input interface could include one or more interfaces compliant with protocols such as DVI, HDMI, VGA, USB, BLUETOOTH, WIFI, among numerous others.

Media presentation interface 602 could comprise one or more components to facilitate presentation of the received media content. By way of example, the media presentation interface could comprise a user interface such as a display screen and/or a loudspeaker, as well as one or more drivers or other components for processing the received media content to facilitate presentation of the content on the user interface.

Network communication interface 604 could comprise a physical network connection mechanism to facilitate communication on a network such as network 206 discussed above, and/or for engaging in direct or networked communication with one or more other local or remote entities. As such, the network communication interface could comprise a wireless or wired Ethernet interface or other type of network interface, for engaging in IP communication and/or other type of network communication.

Further, processing unit 606 could then comprise one or more general purpose processors (e.g., microprocessors) and/or one or more specialized processors (e.g., application specific integrated circuits). And non-transitory data storage 608 could comprise one or more volatile and/or non-volatile storage components, such as optical, magnetic, or flash storage. Further, as shown, non-transitory data storage 608 stores program instructions 612, which could be executable by processing unit 606 to carry out various content-presentation-device operations described here.

Note that, while the above discussion focuses on ad replacement, similar principles could also be applied to facilitate replacement of other types of content aside from ads. For instance, the disclosed principles could be applied to facilitate replacement of an episode of television program that has been presented threshold many times by a set of one or more content presentation devices. And as another example, the disclosed principles could be applied to facilitate replacement of a song or video with a replacement song or video after the song or video has been played threshold many times by a set of one or more content presentation devices, such as through a media streaming program and/or from a local media library.

In these or other examples, detecting threshold many instances of presentation of a particular media segment could be done with ACR in the manner described above for instance. And then dynamic media-content replacement could be responsively applied akin to the DAI described above for instance. Other variations are possible as well.

Exemplary embodiments have been described above. Those skilled in the art will understand, however, that changes and modifications may be made to these embodiments without departing from the true scope and spirit of the invention.

What is claimed is:

1. A computing system comprising:
at least one processing unit;
non-transitory data storage; and
program instructions stored in the non-transitory data storage and executable by the at least one processing unit to carry out operations including:
detecting, through automatic content recognition (ACR), that a particular ad has been presented threshold many times by a set of one or more content presentation devices; and
responsive to the detecting, implementing dynamic ad insertion (DAI) to automatically substitute presentation of a replacement ad for presentation of the particular ad a next time the particular ad would be presented by a content presentation device of the set.

2. The computing system of claim 1, wherein the ACR comprises at least one process selected from the group consisting of fingerprint-based ACR and metadata-based ACR.

3. The computing system of claim 2, wherein the fingerprint-based ACR comprises using fingerprint matching, between digital reference fingerprint data representing the particular ad and digital query fingerprint data representing media content presented by a content presentation device of the set, as a basis to detect presentation of the particular ad.

4. The computing system of claim 2, wherein a media stream carrying media content including the particular ad is steganographically encoded with a watermark indicating presence in the media stream of the particular ad, and wherein the metadata-based ACR comprises using the steganographically encoded watermark as a basis to detect presentation of the particular ad by a content presentation device that presents the media stream.

5. The computing system of claim 2, wherein a transport stream carrying a media stream including the particular ad further carries metadata indicating presence in the media stream of the particular ad, and wherein the metadata-based ACR comprises using the metadata carried by the transport stream as a basis to detect presentation of the particular ad by a content presentation device that presents the media stream.

6. The computing system of claim 5, wherein detecting, through ACR, that a particular ad has been presented threshold many times by a set of one or more content presentation devices comprises receiving signaling generated based on the ACR establishing presentation of the particular ad by the set of one or more content presentation devices.

7. The computing system of claim 1, wherein the set of one or more content presentation devices is a single content presentation device.

8. The computing system of claim 1, wherein the set of one or more content presentation devices is a group of multiple content presentation devices associated with a common user.

9. The computing system of claim 8, wherein detecting, through ACR, that the particular ad has been presented threshold many times by the set of one or more content presentation devices comprises:
tracking a total number of presentations of the particular ad among the content presentation devices of the set, based on the content presentation devices of the set being associated with a common user; and
determining that the tracked total number is at least as great as a predefined threshold number.

10. The computing system of claim 1, wherein detecting, through ACR, that the particular ad has been presented threshold many times by the set of one or more content presentation devices comprises detecting that the set of one of more content presentation devices has presented the particular ad at least a predefined threshold great number of times.

11. The computing system of claim 10, wherein the predefined threshold great number of times is at least two.

12. The computing system of claim 10, wherein detecting that the set of one of more content presentation devices has presented the particular ad at least a predefined threshold great number of times comprises detecting that the set of one of more content presentation devices has presented the particular ad at least a predefined threshold great number of times over a defined sliding window of time.

13. The computing system of claim 1, wherein the detecting is carried out at least in part by the set of one or more content presentation devices.

14. The computing system of claim 1, wherein implementing DAI to cause presentation of a replacement ad in place of the particular ad a next time the particular ad would be presented by a content presentation device of the set comprises:
causing the content presentation device to detect presence of the particular ad in media content that the content presentation device is presenting and to substitute presentation of the replacement ad for presentation of the particular ad.

15. The computing system of claim 14, wherein implementing DAI to cause presentation of a replacement ad in place of the particular ad a next time the particular ad would be presented by a content presentation device of the set further comprises:
provisioning the content presentation device with the replacement ad to be presented in place of the particular ad.

16. The computing system of claim 1, wherein implementing DAI comprises:
detecting, though ACR, an instance of the particular ad in media content being presented by the content presentation device; and
responsive to the detecting of the instance of the particular ad in the media content being presented by the content presentation device, causing the content presentation device to substitute presentation of the replacement ad for presentation of the instance of the particular ad.

17. A method comprising:
detecting, through automatic content recognition (ACR), that a particular ad has been presented threshold many times by a set of one or more content presentation devices; and
responsive to the detecting, implementing dynamic ad insertion (DAI) to automatically substitute presentation of a replacement ad for presentation of the particular ad a next time the particular ad would be presented by a content presentation device of the set.

18. The method of claim 17, wherein the ACR comprises at least one process selected from the group consisting of fingerprint-based ACR and metadata-based ACR.

19. The method of claim 17, wherein the set of one or more content presentation devices is a single content presentation device.

20. The method of claim 17, wherein the set of one or more content presentation devices is a group of multiple content presentation devices associated with a common user, and wherein detecting, through ACR, that the particular ad has been presented threshold many times by the set of one or more content presentation devices comprises:
tracking a total number of presentations of the particular ad among the content presentation devices of the set, based on the content presentation devices of the set being associated with a common user; and
determining that the tracked total number is at least as great as a predefined threshold number.
